(19) United States
(12) Patent Application Publication
(10) Pub. No.: US 2026/0190015 A1
(43) Pub. Date: Jul. 2, 2026

(54) Access Point Discovery for Seamless Roaming

(71) Applicant: Apple Inc., Cupertino, CA (US)

(72) Inventors: Ahmad Reza Hedayat, Carlsbad, CA (US); Jarkko L. Kneckt, Los Gatos, CA (US); Neelakantan Nurani Krishnan, San Diego, CA (US); Pooya Monajemi, Sunnyvale, CA (US); Yong Ho Seok, Cupertino, CA (US); Yong Liu, Campbell, CA (US); Anuj Batra, Redwood City, CA (US)

(21) Appl. No.: 19/417,942

(22) Filed: Dec. 12, 2025

Related U.S. Application Data
(60) Provisional application No. 63/741,304, filed on Jan. 2, 2025.

(51) Int. Cl. H04W 48/16; H04W 76/15

(52) U.S. Cl. CPC H04W 48/16; H04W 76/15

(57) ABSTRACT

This disclosure relates to methods for performing access point discovery for seamless roaming in a wireless local area network. A non-access point wireless device can generate and transmit a basic service set transition management query frame to an access point wireless device. The query frame can include an indication that it is for access point discovery. The access point wireless device can generate and transmit a basic service set transition management request frame to the non-access point wireless device in response. The request frame can include query response status information to indicate successful or unsuccessful query output. In the case of successful query output, the request frame can include the requested access point discovery information.

### PRIORITY INFORMATION

This application claims priority to U.S. provisional patent application Ser. No. 63/741,304, entitled “Access Point Discovery for Seamless Roaming,” filed Jan. 2, 2025, which is hereby incorporated by reference in its entirety as though fully and completely set forth herein.

### TECHNICAL FIELD

The present application relates to wireless communication, including techniques and devices for performing access point discovery for seamless roaming in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. Providing strong support for mobility, potentially including for roaming between access points in a WLAN setting, can provide significant benefits for mobile devices, but can also come with additional design challenges. Accordingly, improvements in the field are desired.

### SUMMARY

Embodiments are presented herein of, inter alia, systems, apparatuses, and methods for devices to perform access point discovery for seamless roaming in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a wireless device can request access point discovery information from its serving access point using a basic service set transition management (BTM) query/request framework. This can include using a reason/code configured to provide an indication that access point discovery is requested in a BTM query generated and provided by the wireless device to its serving access point. The BTM query can further indicate any of various query types, criteria, and/or specific information requested for the access point discovery query.

The access point discovery can further include the serving access point generating and providing a BTM request to the wireless device, which can include an indication of whether the query output is successful. If the query output is successful, the BTM request can include the requested access point discovery information.

The access point discovery information can be used by the wireless device to select an access point to which to roam during a seamless roaming procedure. Use of such a process to obtain access point discovery information can potentially benefit the wireless device and the wireless communication system in which the wireless device is operating by supporting quick and efficient discovery of access points that fit the operating circumstances and priorities of the wireless device, for example potentially including improved consideration of the mobility, target Quality of Service, and/or other factors.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for performing access point discovery for seamless roaming in a wireless local area network, according to some embodiments;

FIG. 6 illustrates aspects of an example scenario in which a roaming scan could be performed by a wireless device, according to some embodiments;

FIGS. 7-8 illustrate example aspects of passive/active scanning techniques for performing access point discovery, according to some embodiments;

FIGS. 9-10 illustrate example aspects of possible access point assisted access point discovery techniques, according to some embodiments;

FIG. 11 is a signal flow diagram illustrating example aspects of one possible seamless roaming sequence, according to some embodiments;

FIG. 12 is a signal flow diagram illustrating example aspects of a possible seamless roaming procedure that includes an enhanced basic service set transition management (BTM) procedure to perform access point assisted access point discovery, according to some embodiments;

FIGS. 13-14 illustrate example aspects of possible enhanced BTM query frame formats, according to some embodiments;

FIG. 15 is a table indicating a variety of possible query codes and corresponding query criteria that could be used for an enhanced BTM query frame, according to some embodiments;

FIGS. 16-17 illustrate aspects of example scenarios in which various types of access point discovery queries could be useful, according to some embodiments;

FIG. 18 illustrates example frame format aspects of a possible enhanced BTM query that includes an extended request element, as well as a possible BTM request that could be provided in response, according to some embodiments; and

FIG. 19 illustrates example aspects of another possible modified BTM request frame, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

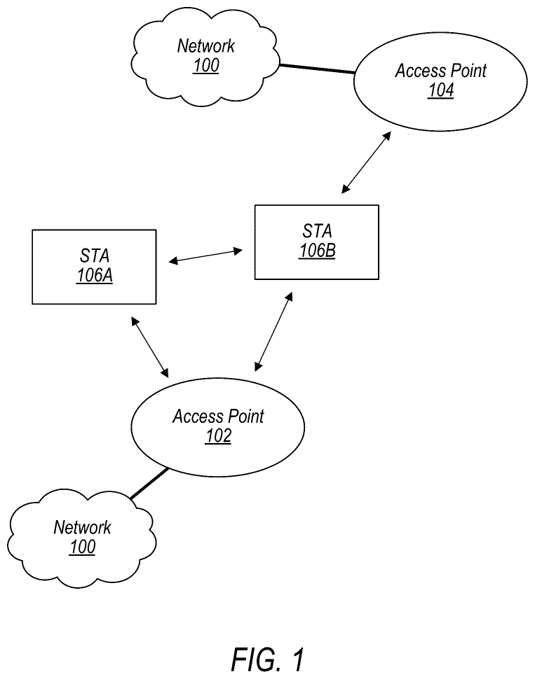

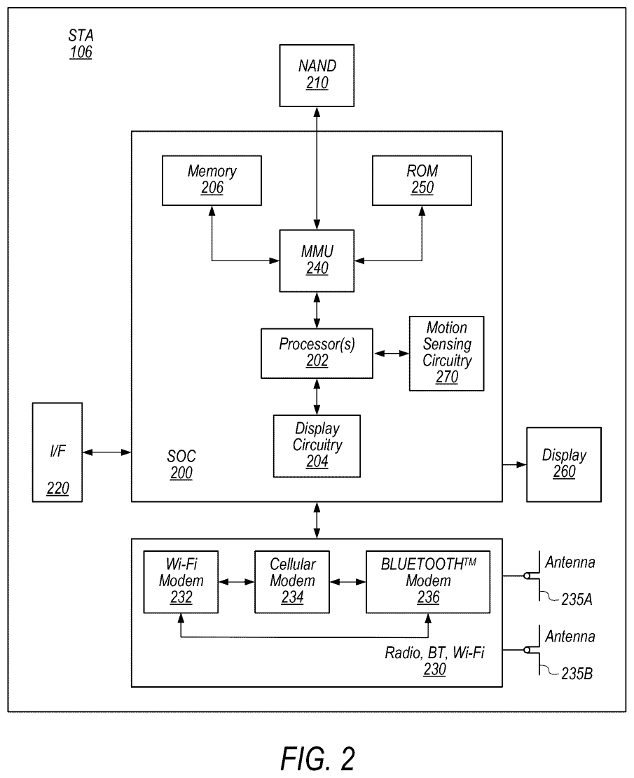

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for access point discovery for seamless roaming in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for performing access point discovery for seamless roaming described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

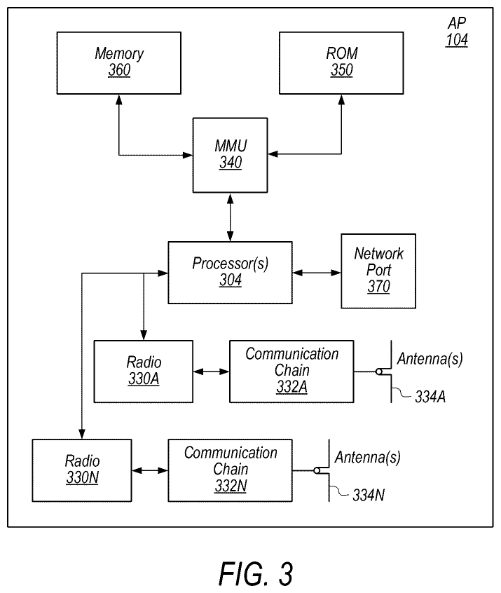

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as performing access point discovery for seamless roaming, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

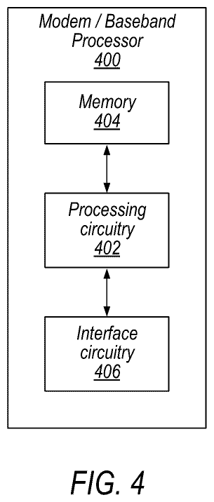

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as performing access point discovery for seamless roaming, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

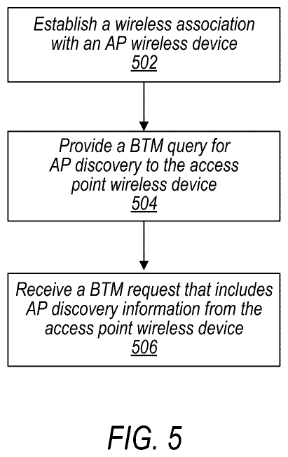

### FIG. 5—Access Point Discovery for Seamless Roaming Flowchart

FIG. 5 is a flowchart diagram illustrating a method for performing access point discovery for seamless roaming in a WLAN, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

An access point (AP) wireless device may provide information and attributes of one or more basic service sets (BSSs). In some embodiments, the AP wireless device may be an AP multi-link device (MLD), which may be capable of providing a BSS on each of multiple links, such as on a 2.4 GHz link, a 5 GHz link, and/or a 6 GHz link. The AP wireless device may operate in a standalone manner or may be affiliated with one or more other devices, e.g., as part of a larger network. For example, the AP wireless device could be a member of a seamless mobility domain (SMD) or multi-link multi-device (MLMD) logical entity, which could include multiple AP wireless devices, in some embodiments.

The AP wireless device may establish a wireless association with one or more non-AP (or “STA”) wireless devices (502). Such wireless associations may be established using Wi-Fi, wireless communication techniques that are based at least in part on Wi-Fi, and/or any of various other wireless communication technologies, according to various embodiments. For example, an access point (AP) wireless device may provide (e.g., broadcast) beacon transmissions including information for associating with the AP wireless device, and one or more other wireless devices (e.g., non-AP wireless devices) may request to associate with the AP wireless device using the information provided in the beacon transmissions, as one possibility. Use of (e.g., unicast) probe requests and probe responses may also be possible, in some instances, for a non-AP wireless device to obtain AP parameters and/or other system information for the AP wireless device. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

For example, at least according to some embodiments, performing a downlink data transmission from the AP wireless device to a non-AP wireless device in such a wireless local area network may include contending for medium access (e.g., to avoid collisions and potential interference), and, once medium access is obtained, transmitting a physical layer (PHY) protocol data unit (PPDU) (which may also be referred to as a downlink frame) to the destination wireless device. The downlink frame may include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs). Note that other types of transmissions (e.g., including triggered uplink frames, enhanced distributed channel access (EDCA) uplink frames, transmission opportunity (TXOP) sharing for peer-to-peer (P2P) communications, etc.) may also be possible in such a wireless local area network.

A non-AP wireless device can generate a BSS transition management (BTM) query frame and transmit the BTM query frame to the AP wireless device, which in turn can receive the BTM query frame (504). The BTM query frame can include an indication that the BTM query is for AP discovery. For example, reason or cause code information for the BTM query can be set to a value configured to indicate that the BTM query is for AP discovery, in some embodiments.

The BTM query can further indicate the type(s) of AP discovery that the non-AP wireless device is requesting, and/or indicate one or more query parameters or criteria for the AP discovery requested. According to various embodiments, for example, AP discovery could be requested for APs in the same SMD or MLMD as the serving AP wireless device, for APs in one or more different SMDs or MLMDs than the serving AP wireless device (e.g., with SMD/MLMD identification information for one or more specific SMDs/MLMDs provided, or without specifying any particular SMDs/MLMDs, as various possibilities), for APs in any SMD/MLMD, for neighbor APs to one or more specified APs, for APs with load in a certain (e.g., indicated) range, for one or more specific APs, for APs operating in a certain (e.g., indicated) frequency range, and/or for APs according to any of various other possible constraints.

The BTM query can also indicate one or more coverage criteria for the requested AP discovery, according to some embodiments. The coverage criteria could be signal strength-based or hop-based, as some possibilities. For example, the BTM query can request AP discovery information for APs that meet an indicated received signal strength indicator (RSSI) requirement (e.g., that have at least a certain RSSI value). As another example, the BTM query can request AP discovery information for APs that are within a certain number of hops (e.g., 1-hop, 2-hops, etc.) of the serving AP wireless device.

In some embodiments, the BTM query frame can request one or more specific types of AP parameter information for APs indicated in the AP discovery information. For example, for scenarios in which AP discovery information is requested for APs operation on 6 GHz, transmit power envelope (TPE) information for the reported APs can be requested. Additionally, or alternatively, one or more specific information elements (e.g., BSS load, and/or any of various other possibilities) could be requested to be reported for the APs reported in the AP discovery information.

The serving AP wireless device can generate a BTM request frame and transmit the BTM request frame to the non-AP wireless device, which in turn can receive the BTM request frame (506). The BTM request frame can include query response status information to indicate whether the query output is successful or unsuccessful. For example, if the AP wireless device is unable to provide the requested AP discovery information, the query response status information could indicate that the query output is unsuccessful, while if the AP wireless device is able to provide the requested AP discovery information, the query response status information could indicate that the query output is successful. Other details or specific information could additionally or alternatively be provided, for example to account for scenarios in which there is a limitation on the number of reported APs and/or other constraints on the success of the query output.

For (at least partially) successful query output scenarios, the BTM request frame can further include AP discovery information. The AP discovery information can include neighbor report information and/or reduced neighbor report (RNR) information for APs that meet the AP type, coverage criteria, and/or other criteria indicated by the BTM query, according to some embodiments. For example, in some embodiments, RNR information can be provided in a candidate list entries field of the BTM request frame. In some instances, one or more fields or sub-fields that have specified purposes for BTM request frames provided in response to BTM query frames with other reason or cause codes can be reserved for the BTM request frame provided in response to the BTM query frame with AP discovery as the reason or cause code. For example, a disassociation timer field, a link removal imminent subfield in a request mode field, and/or any of various other possible fields/subfields, could have reserved values in the BTM request frame, e.g., for aspects not applicable to the ongoing signaling between the non-AP and the AP, according to various embodiments.

In scenarios in which additional information for APs indicated in the AP discovery information is requested, the BTM request frame can also include such information. For example, in case any specific information elements are requested, the BTM request frame can include multi-link (ML) elements to report the selected elements for the neighboring APs.

Note additionally that in some embodiments, it can be possible that the same or a similar frame format can be used by the AP wireless device to provide an unsolicited BTM request. For example, in some instances, it can be possible that the AP wireless device determines to provide AP discovery information to a non-AP wireless device based on one or more configured conditions being met at the AP wireless device that trigger the AP wireless device to do so. In such a scenario, the AP wireless device can provide a BTM request that includes AP discovery information to the non-AP wireless device without prompting by the non-AP wireless device. Such a technique can be limited to use between wireless devices that are configured to support such operation (e.g., between an ultra-high reliability (UHR) AP and an UHR STA, as one possibility), in some instances.

The AP discovery information received by the non-AP wireless device can be used to facilitate seamless roaming operation, according to some embodiments. For example, the non-AP wireless device can rank APs including those indicated in the AP discovery information for roaming, and when a roaming trigger occurs, select an AP to which to roam based on the rankings and perform a ‘quick’ RSSI check to confirm that the selected AP is the most suitable (e.g., according to the AP selection configuration for the non-AP wireless device) for the non-AP wireless device before performing a seamless roaming procedure to the selected AP.

Thus, according to the method of FIG. 5, it can be possible to efficiently perform AP discovery for seamless roaming using a BTM query and request framework, which can allow a non-AP wireless device to smoothly transition from association with one AP to association with another AP with minimal disruption to data communication, and potentially without losing its authentication or association state, at least according to some embodiments.

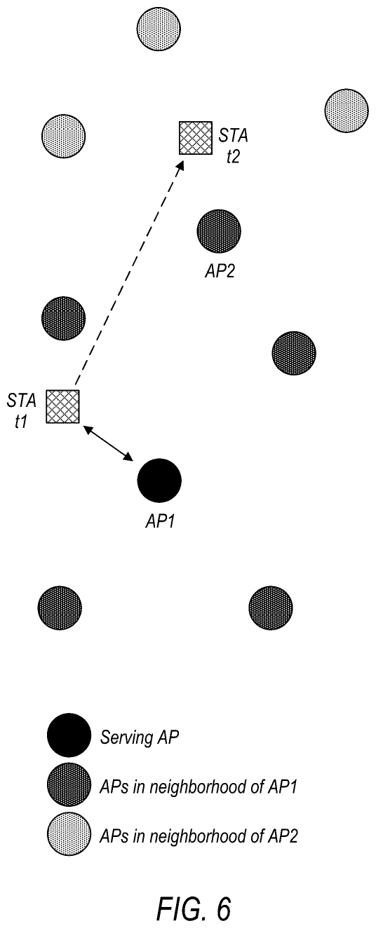

### FIGS. 6-19 and Additional Information

FIGS. 6-19 illustrate further aspects that might be used in conjunction with the method of FIG. 5. It should be noted, however, that the exemplary details illustrated in, and described with respect to, FIGS. 6-19 are not intended to be limiting to the disclosure as a whole: numerous variations and alternatives to the details provided herein below are possible and should be considered within the scope of the disclosure.

For a wireless device operating in a wireless local area network environment, a roaming scan can include discovering (and acquiring information for) neighboring access points, and ranking neighboring/target access points, at least according to some embodiments. FIG. 6 illustrates an example scenario in which such a roaming scan could be performed. In the illustrated example, a STA is initially associated with AP1. In its initial location (e.g., at time t1), it could be useful for AP1 to provide roaming candidate information for APs from the AP1 neighborhood. In its later location (e.g., at time t2), it could be more useful for AP1 to provide roaming candidate information for APs from the AP2 neighborhood. Thus, it can be useful to provide support for multiple types of roaming candidate AP discovery through a serving AP, such as according to the various techniques described herein.

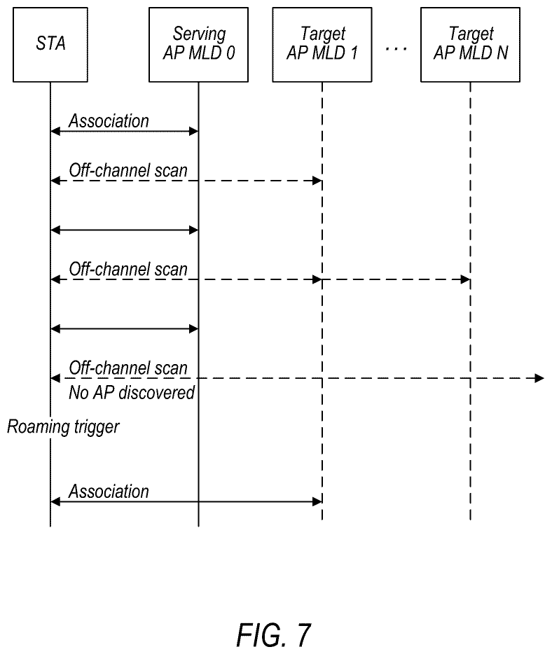

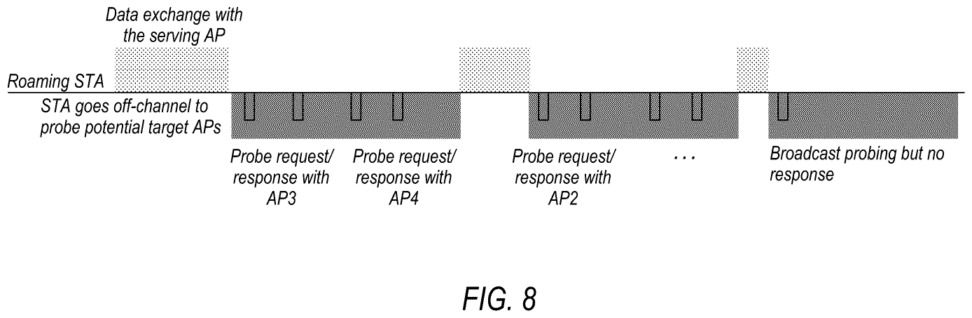

One type of technique for AP discovery can include passive/active scanning. FIGS. 7-8 illustrate example aspects of such a technique, according to some embodiments. As shown, a STA can associate with a serving AP (e.g., “AP MLD 0”), then perform off-channel scanning in between data exchanges with the serving AP. These off-channel scanning operations can include performing probe request/response exchanges with other APs discovered to obtain AP information for them. Once a roaming trigger occurs, the STA can then roam to a selected target AP (e.g., “AP MLD 1”). Such off-channel scanning can be performed without assistance from the serving AP, but can be relatively power consuming, can impact ongoing (e.g., low latency) data exchange, and it may be the case that no integrity protection is available for the passive/active scanning operations.

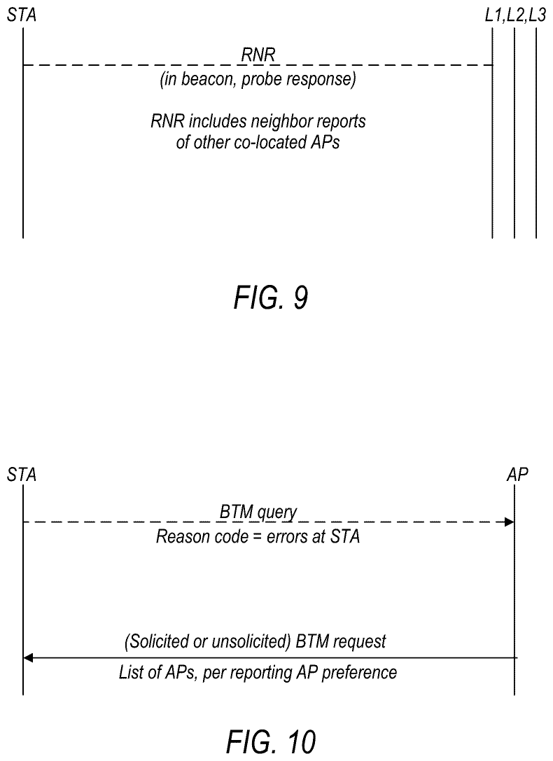

Another type of technique for AP discovery can include discovery via the serving AP, e.g., using a basic service set transition management (BTM) procedure. Such discovery via serving AP can potentially be performed without off-channel activity and with less power consumption than passive/active scanning, and can be protected, at least in some embodiments. FIGS. 9-10 illustrate example aspects of such a technique, according to some embodiments. In particular, FIG. 9 is a signal flow diagram illustrating provision of a reduced neighbor report (RNR) from an AP MLD to a STA. The RNR can include neighbor reports of other co-located APs for the AP MLD. However, the RNR can be missing information for non-co-located APs. FIG. 10 is a signal flow diagram illustrating a possible BTM procedure between a STA and an AP. BTM can be used to address STA failures (e.g., excessive frame loss, excessive delay, failed 4-way handshake, too many message integrity check failures, etc.). Thus, a BTM query frame can include reason code information indicating errors at the STA, and a BTM request frame can (e.g., in response or in an unsolicited manner) provide a list of APs, which can be according to the preference of the reporting AP (e.g., for load-balancing and/or any of various other possible reasons), possibly with no STA preference considered, in the illustrated scenario. Additionally, it can be the case that a STA cannot query its serving AP about unknown neighbor APs in the illustrated scenario.

Access point facilitated roaming, which can also sometimes be referred to as seamless roaming, can allow a wireless device to quickly transition from active association with one AP device to another AP device. For seamless roaming, a set of AP MLDs can be grouped into a virtual entity, which can be referred to as a multi-link multi-device (MLMD), or as a seamless mobility domain (SMD), among various possibilities, e.g., to help coordinate certain management functions among the set of AP MLDs. Roaming between AP MLDs in a MLMD or SMD can potentially be faster and more efficient, with less interruption to the roaming STA MLD. Once a STA is associated with an AP MLD in such a system, the STA can potentially keep its authentication and association state in roaming to another AP MLD.

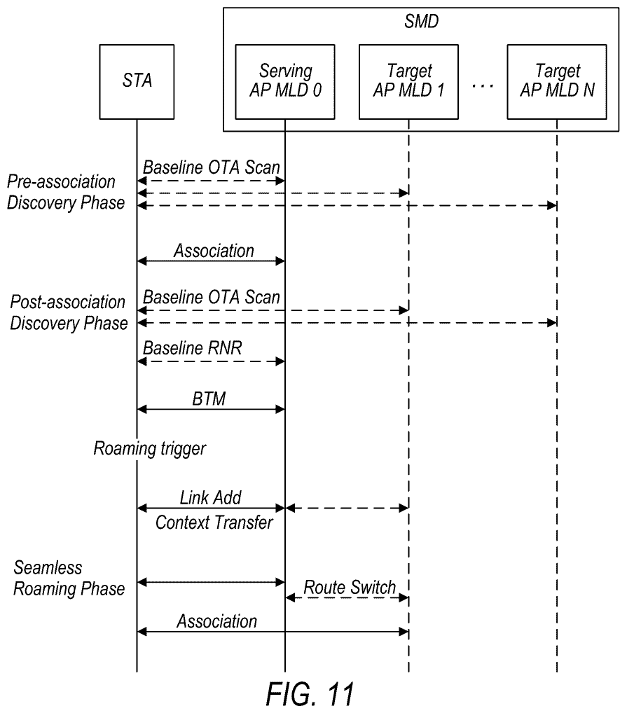

FIG. 11 is a signal flow diagram illustrating example aspects of one such possible roaming sequence, according to some embodiments. As shown, a STA can perform a baseline over-the-air (OTA) scan to select an initial AP with which to associate in a pre-association discovery phase. The STA can perform association with a serving AP MLD. The STA and the serving AP MLD can perform a post-association discovery phase (e.g., pre-roaming activity), which can include scanning and/or performing discovery of neighbor AP devices via reduced neighbor report (RNR), basic service set transition management (BTM), and/or multi-link (ML) probing messages, among various possibilities. These activities can help the STA MLD prepare for the possibility that roaming to a neighbor AP device is advantageous, e.g., due to mobility, congestion, wireless medium condition changes, and/or for any other reason, by obtaining signal strength information, capability information, and/or other types of information for neighbor AP devices. Once a roaming trigger occurs, the STA can exchange link addition request and response messages to add a link with a target AP MLD. The serving AP MLD can provide static context transfer (e.g., MAC and PHY capability information, etc.) for the STA MLD to the target AP MLD. The STA MLD and the serving AP MLD can exchange route switch and response messages to accomplish the STA's roaming from the serving AP MLD to the target AP MLD. The serving AP MLD can provide dynamic context transfer (e.g., sequence number information, packet number information, etc.) for the STA MLD to the target AP MLD. After the route switching, the STA MLD and the target AP MLD can be associated and can perform data exchange.

Without efficient AP discovery methods, a roaming STA may have to perform neighborhood discovery on its own, potentially sacrificing power, time, and security due to off-channel scanning, or rely on methods where a serving AP forces disassociation, which can leave the STA with poor choices of target APs. Thus, while seamless roaming has the potential to enable a better roaming experience, without efficient AP discovery methods, some advantages may be lost due to a STA MLD ping-ponging among several AP MLDs before settling on an AP MLD. Further, even if the serving AP MLD prescribes a target AP MLD to a roaming STA MLD, it could ignore the STA requirements and target Quality of Service (QoS) if improved AP discovery techniques are not provided. Accordingly, various possible techniques are described herein for performing AP discovery for a STA MLD that is roaming in a (e.g., 802.11 based) SMD or MLMD, or otherwise roaming among multiple AP MLDs. As further described herein, compared to existing discovery methods, these techniques can potentially be more efficient and less power consuming, and can reduce or avoid the need for off-channel (scanning) activity, which can be useful for low latency data transmission. These techniques can also have full message integrity check and protection as in management protection methods, at least according to some embodiments.

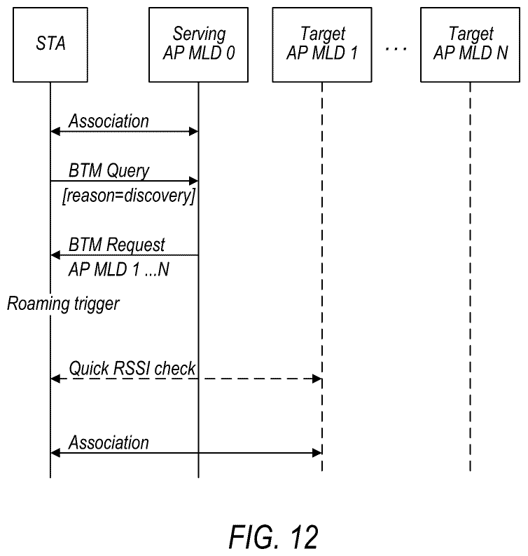

According to some embodiments, an enhanced BTM procedure can be used to perform serving AP assisted AP discovery for seamless roaming. FIG. 12 is a signal flow diagram illustrating example aspects of such a procedure. As shown, a “discovery” reason code can be used for such a BTM query. The enhanced BTM query can provide information indicating parameters for the AP discovery query, such as if the STA is querying for neighboring APs within a certain coverage, neighboring APs that may belong to a different SMD/MLMD, neighboring APs that operate in 6 GHz, neighboring APs with a lower BSS load, capabilities of an identified AP, etc. The serving AP can provide an enhanced BTM request in response to the enhanced BTM query, which can indicate the requested AP discovery information. At least in some embodiments, the BTM request can be provided relatively soon after the BTM query frame is received, e.g., to facilitate the requesting STA receiving the AP information before the STA needs to roam. After a roaming trigger, the STA can then potentially perform a quick received signal strength indicator (RSSI) check and perform association signaling with the selected target AP.

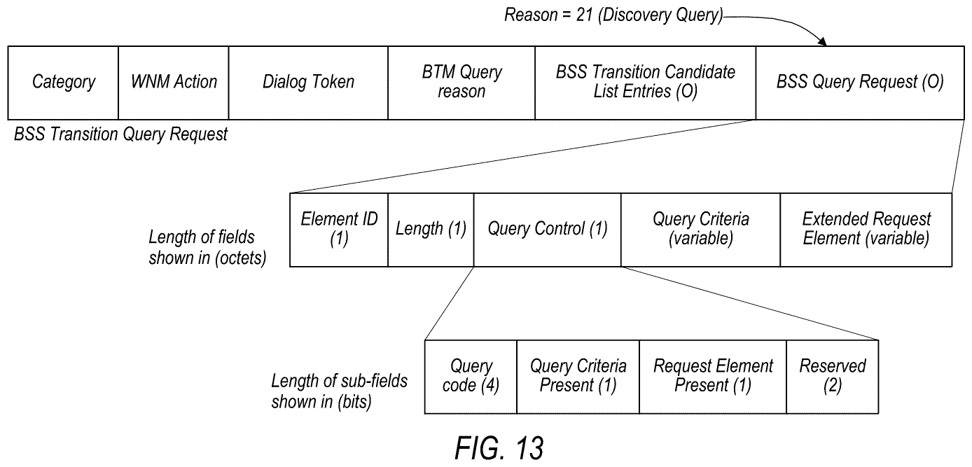

FIG. 13 illustrates example aspects of a possible enhanced BTM query frame format, according to some embodiments. A new BTM query reason: “discovery query” (e.g., reason code 21, as one possibility) can be indicated in the BTM query reason portion. A BSS Transition Query Request portion can be provided for the discovery query. As shown, the BSS Transition Query Request portion can include one-octet-each Element ID, Length, and Element ID extension fields. A one octet Query Control field can include Query Type, Query Criteria Present, Request Element Present, and Reserved subfields. A Query Criteria field and an Extended Request Element field (e.g., of variable length) can also be included, in some scenarios.

The Query Type and Criteria can be used to indicate a specific query that a roaming STA has during its pre-roaming procedure. For example, a roaming STA could be looking for all neighboring APs, in the same MLMD, within the serving AP neighborhood, as one possibility. To limit the number of reported APs to be within a practical neighborhood, one or more default or indicated coverage criteria could be used; the coverage criteria could be RSSI-based or hop-based, according to various embodiments. For example, a RSSI criterion could be set by the STA; this could request that APs that are within the specified RSSI coverage of the reporting AP be reported. As another example, instead of AP-AP RSSI, the STA could ask for 1 hop AP neighbors or 2- hop AP neighbors of the serving AP. Note that depending on deployments, hop-based coverage criteria for 2.4 GHz APs could lead to a large number of 2.4 GHz APs being reported.

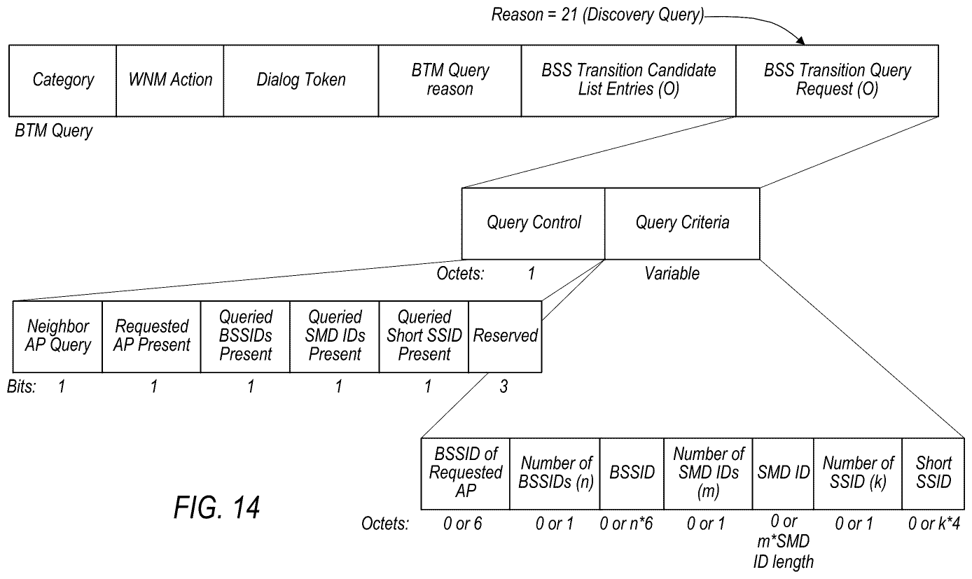

FIG. 14 illustrates example aspects of another possible BTM query frame format, according to some embodiments. In this illustrated example, the BSS Transition Query Request field can be present when the BSS Transition Query Reason field is set to the Discovery Query reason code. As shown, the BSS Transition Query Request field can include Query Control and Query Criteria fields. The Neighbor AP Query field can be set if the neighbor APs of the requested AP are requested. Additionally, it can be the case that the APs that match the BSSID, SMD ID/MLMD ID, or short SSID of the Query Criteria field are requested. The Requested AP Present field can be set if the Query Criteria field contains a BSSID of Requested AP field that specifies the MAC address of the AP for which neighbor APs are queried; otherwise, the neighborhood of the serving AP is queried, and the field is not present, at least according to some embodiments. It can be the case that the Queried BSSIDs Present field is set if the Query Criteria field contains the Number of BSSIDs and BSSIDs fields; otherwise, it can be the case that these fields are not present. Similarly, it can be the case that the Queried SMD IDs Present field is set if the Query Criteria field contains the Number of SMD IDs and SMD IDs fields; otherwise, it can be the case that these fields are not present. Likewise, it can be the case that the Queried Short SSID Present field is set if the Query Criteria field contains the Number of Short SSIDs and Short SSIDs fields; otherwise, it can be the case that these fields are not present. In the Query Criteria field, the BSSID of Requested AP field, if present, can indicate the BSSID of the AP for which neighbor AP reporting is requested. The number of BSSIDs field, if present, can indicate the number of BSSIDs (n) in the Query Criteria field. The BSSID field, if present, can contain the indicated the number of BSSID values, e.g., to specify the queried BSSIDs. The number of SMD IDs field, if present, can indicate the number of SMD IDs (m) in the Query Criteria field. The SMD ID field, if present, can contain the indicated the number of SMD ID values, e.g., to specify the queried SMDs. The number of Short SSIDs field, if present, can indicate the number of Short SSIDs (k) in the Query Criteria field. The Short SSID field, if present, can contain the indicated number of Short SSID values, e.g., to specify the queried Short SSIDs. Thus, it can be the case that one or more of the bits in the Query Control field are set, and in such a case, the corresponding respective field(s) in the Query Criteria are present.

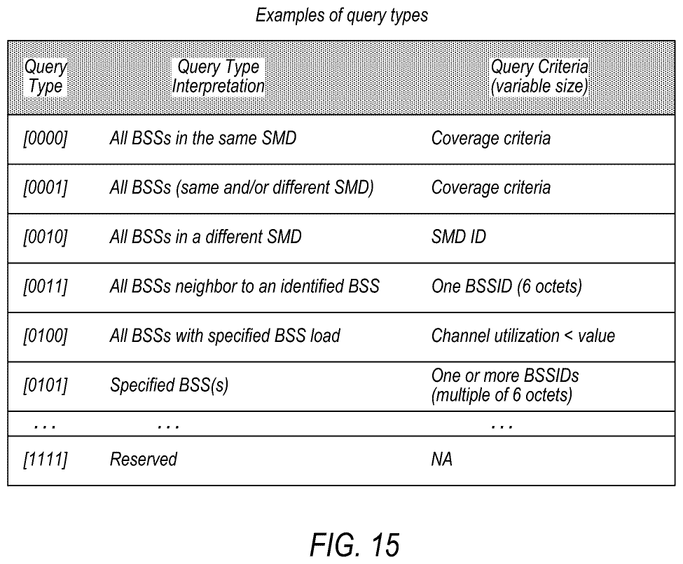

FIG. 15 is a table indicating a variety of possible query codes and corresponding query criteria that could be used for such an enhanced BTM query frame, in some embodiments, which include possibilities for requesting information for BSSs in the same and/or different SMDs, BSSs that are neighboring to an identified BSS, BSSs with BSS load in a certain range, one or more specific BSSs. Variations of the illustrated query types and criteria, as well as other possible query types and criteria, can also or alternatively be used, as desired.

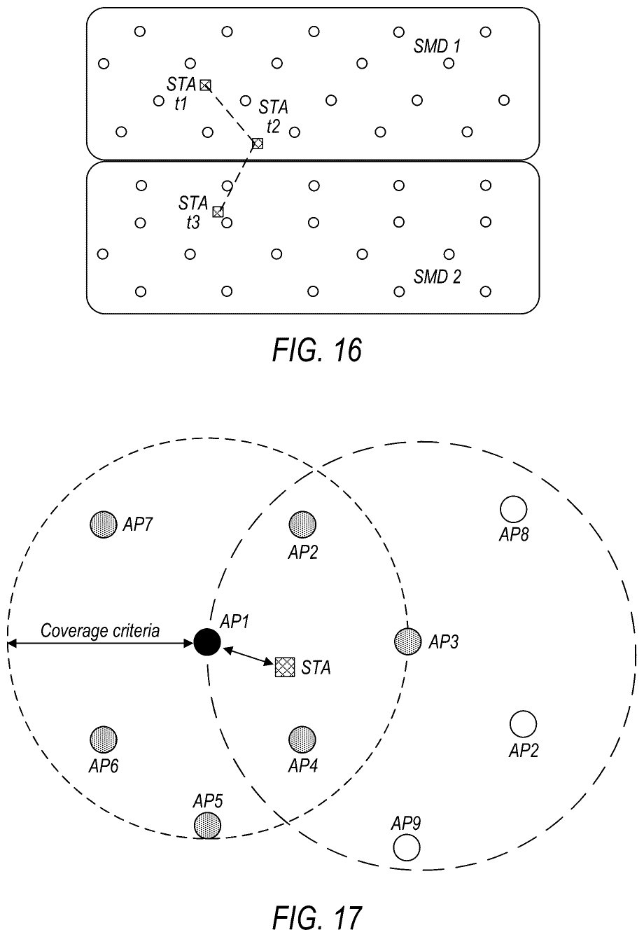

FIG. 16 illustrates aspects of an example scenario in which various types of queries could be useful. As shown, a STA may undergo mobility between times t1, t2, and t3, in the example scenario, while potentially remaining associated to the same serving AP in SMD 1. At the various times, it could be the case that query type 0000 (e.g., according to the table of FIG. 15) with query criteria: coverage criteria could be used, or that query type 0001 with query criteria: coverage criteria could be used, or that query type 0010 with query criteria: SMD ID (or MLMD ID) could be used. For example, depending on how large of a SMD is defined, it could be useful for a roaming STA that gets close to the edge of the current SMD to discover APs within an adjacent SMD. The two illustrated SMDs could be in two adjacent floors of a building, or two adjacent areas of a floor, or could be configured according to any of various other deployments, according to various possible implementations. Note that, in some scenarios, the neighbor report or RNR can be updated to carry SMD ID (or MLMD ID).

FIG. 17 illustrates aspects of an example scenario in which still another type of query could be useful. In particular, in the illustrated scenario, a roaming STA may want to discover neighboring APs of another (not the serving) AP. In this case, query type 0011 (e.g., according to the table of FIG. 15) with query criteria: BSSID of the reference AP could be used. For example, the STA could be moving near AP3 in the illustrated scenario, such that it may be more useful to know AP3's neighbors ahead of time; thus, this query can be used to expand the discovered neighboring APs in the direction of the STA movement, in some embodiments.

Another example scenario could include when a STA requests that its serving AP report neighboring APs operating on 6 GHz (e.g., via a dedicated query type). In this case, the BTM request can include transmit power envelope (TPE) information for the reported APs, at least in some embodiments. For example, the TPE and attributes illustrated in FIGS. 9-712 and 9-713 of IEEE 802.11me 2024 could be carried in the BTM request for the reported APs, in some embodiments.

Still another example scenario could include when a STA requests that its serving AP report one or more specific information elements (IEs) (e.g., BSS load, as one possibility) for the requested BSSs. In this case, one or more BSSIDs can be indicated in the query criteria. Request element and extended request element fields (e.g., which can be according to FIG. 9-229 and FIG. 9-230 of IEEE 802.11me 2024, in some embodiments) of the enhanced BTM query can be used to indicate such requests.

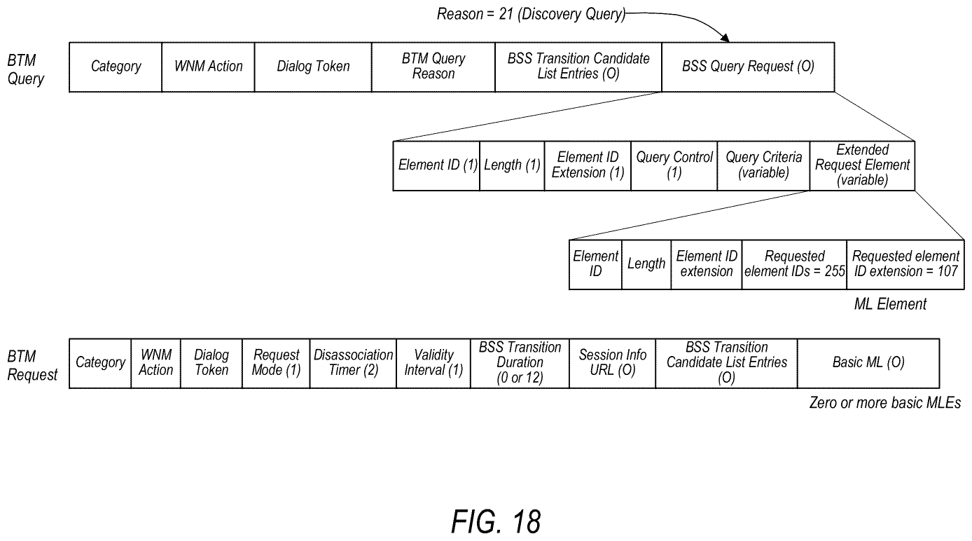

FIG. 18 illustrates example frame format aspects of a possible enhanced BTM query that includes such an extended request element, as well as a possible BTM request that could be provided in response, according to some embodiments. Such formats could be used, for example, for a STA to request that its serving AP report selected elements of one or more neighboring AP MLDs, and for the serving AP to report the requested selected elements. The one or more AP MLDs for which the selected elements are requested can be indicated in the query criteria, in some embodiments.

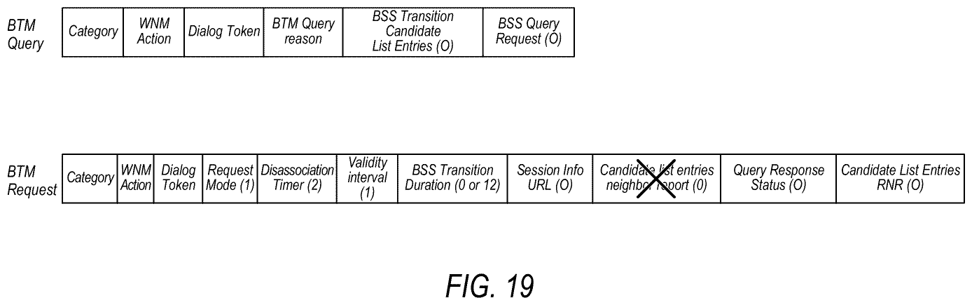

FIG. 19 illustrates example aspects of another possible modified BTM request frame, according to some embodiments. In the illustrated example, for query reason: discovery query, a BTM request can carry RNR (e.g., instead of neighbor report) information in the candidate list entries. This approach can be extended to scenarios when an unsolicited BTM request can be sent to a STA (e.g., a UHR STA that supports such a format, in some instances). It can be the case that the candidate list entries with neighbor report field is not provided. The disassociation timer field and the link removal imminent subfield in the request mode field can be reserved in a BTM request frame that is sent in response to a BTM query frame with reason code set to discovery query, at least in some embodiments. Additionally, a new optional field could be included to indicate query response status. For example, such a field could be used to indicate whether successful or unsuccessful query output is being provided in response to the BTM query, and/or other specifics such as limitations on the number of reported APs.

As described herein, in some embodiments, an AP, such as a UHR AP, can prepare a BTM Request frame in response to a BTM Query frame or to be sent unsolicited to one or more STAs, or a Neighbor Report Response frame, or an ANQP Response frame. In at least some such embodiments, the AP can be configured to apply the following rules for each the Neighbor Report element corresponding to a neighboring AP that it includes in the BTM Request frame. When a UHR AP sends a BTM Request frame, Neighbor Report Response frame, or ANQP response frame (that includes a Neighbor Report ANQP-element), to a UHR non-AP STA or to a broadcast address, then the included Neighbor Report elements shall include at least the following elements, for each reported UHR AP, i.e. each neighboring AP that is reported in a Neighbor Report element: BSS load, RSNE, RSNXE, UHR Operation, UHR Capabilities, Supported Rates and BSS Membership Selectors, Extended Supported Rates, BSS Membership Selectors and the SMD Information element (if the reported AP is part of a different SMD), Transmit Power Envelope (TPE) element, and AP Transmit Power element, TPC (transmit power control) Report element. Note that in other scenarios an AP can be configured to require a different set of elements or to not require a specific set of elements in such frames, according to various embodiments.

In some embodiments, for each AP that is affiliated with an AP MLD that is part of a SMD, the BSS Load element that is reported in a Neighbor Report element in a BTM Request frame, Neighbor Report Response frame or ANQP Response frame can be generated according to the following rules. The BSS Load that is measured and reported by each AP that is affiliated with an AP MLD that is part of a SMD, which can be determined as follows, can be included. Each BSS Load can be measured over the interval BSS Load Channel Utilization Beacon Interval, which can be the same value across all APs in the SMD. The BSS Load content can be updated as often or more as BSS Load Update Rate, which can also be shared across all APs in the SMD. The values of BSS Load Channel Utilization Beacon Interval and BSS Load Update Rate can be reported in a SMD Information element that each AP in the SMD can share with its associated STAs during association frame exchanges. The BSS Load Channel Utilization Beacon Interval field can be set to the number of consecutive beacon intervals during which the channel utilization is measured, by the APs affiliated with AP MLDs belonging to the SMD. The APs can set dot11ChannelUtilizationBeaconIntervals to the value obtained from this field. The BSS Load Update Rate field can be set to the number of DTIM beacon intervals between which new BSS Load element values are reported in Beacon frames transmitted by APs affiliated with AP MLDs belonging in the SMD. As an example, the value of BSS Load Update Rate field can be 1 to 50 beacon intervals. An AP that is affiliated by an AP MLD that is managed by an SMD can accordingly be configured (e.g., to comply with a wireless communication technology in use, such as an 802.11 protocol) to set dot11ChannelUtilizationBeaconIntervals to the value of the BSS Load Channel Utilization Beacon Interval field that the AP advertises in the SMD Information element. An AP that is affiliated by an AP MLD that is managed by an SMD can in turn be configured (e.g., similarly to comply with a wireless communication technology in use) to update the content of the BSS Load element, reported in Beacon and Probe Response frames, in intervals that are not larger than the BSS Load Update Interval field that the AP advertises in the SMD Information element. Note that in other scenarios an AP can be configured to generate the BSS load element, and/or any of various other elements, of a Neighbor Report element in a BTM Request frame, Neighbor Report Response frame or ANQP Response frame such as described herein, in a different manner (e.g., following a different set of rules), according to various embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
transmitting, to a first access point (AP), a basic service set (BSS) transition management (BTM) query frame that includes an indication that the BTM query frame is for AP discovery; and
receiving, from the first AP, in response to the BTM query frame, a BTM request frame that includes AP discovery information.

2. The method of claim 1,
wherein the BTM query frame requests AP discovery information for APs that meet one or more specified coverage criteria.

3. The method of claim 1,
wherein the first AP is in a first multi-link multi-device (MLMD),
wherein the BTM query frame requests AP discovery information for APs in the first multi-link multi-device (MLMD).

4. The method of claim 1,
wherein the BTM query frame requests AP discovery information for APs in any multi-link multi-device (MLMD).

5. The method of claim 1,
wherein the first AP is in a first multi-link multi-device (MLMD),
wherein the BTM query frame requests AP discovery information for APs in a second multi-link multi-device (MLMD).

6. The method of claim 1,
wherein the BTM query frame requests AP discovery information for neighbor APs to a second AP.

7. The method of claim 1,
wherein the BTM query frame requests AP discovery information for APs with load within an indicated range.

8. The method of claim 1,
wherein the BTM query frame requests AP discovery information for one or more specific APs.

9. The method of claim 1,
wherein BTM query frame requests AP discovery information for APs operating in an indicated frequency range.

10. A processor comprising memory configured to cause the processor to perform operations comprising:
generating a basic service set (BSS) transition management (BTM) query frame that includes an indication that the BTM query is for AP discovery; and
receiving a BTM request frame that includes query response status information indicating successful or unsuccessful query output.

11. The processor of claim 10,
wherein the BTM query frame indicates one or more coverage criteria for the AP discovery information, wherein the one or more coverage criteria include at least one of:
a signal strength-based criterion; or
a hop-based criterion.

12. The processor of claim 10,
wherein the BTM query frame indicates that AP discovery information is requested for at least one of:
one or more specific multi-link multi-devices (MLMDs);
any MLMD;
one or more specific APs;
neighbor APs to one or more specific APs;
APs with load in a specific load range; or
APs that operate in a specific frequency range.

13. The processor of claim 10,
wherein the BTM query frame requests one or more specific types of AP parameter information for APs indicated in the AP discovery information.

14. The processor of claim 10,
wherein query response status information indicates successful query output,
wherein the BTM request frame further includes AP discovery information.

15. An access point (AP) wireless device, comprising:
one or more antennas;
one or more radios operably coupled to the one or more antennas; and
a processor operably coupled to the one or more radios;
wherein the AP wireless device is configured to:
receive, from a non-AP wireless device, a basic service set transition management (BTM) query frame that includes an indication that the BTM query is for AP discovery; and
transmit, to the non-AP wireless device, in response to the BTM query frame, a BTM request frame that includes AP discovery information.

16. The AP wireless device of claim 15,
wherein the BTM query frame indicates one or more coverage criteria for the AP discovery information, wherein the one or more coverage criteria include at least one of:
a signal strength-based criterion; or
a hop-based criterion.

17. The AP wireless device of claim 15,
wherein the BTM query frame indicates that AP discovery information is requested for at least one of:
one or more specific multi-link multi-devices (MLMDs);
any MLMD;
one or more specific APs;
neighbor APs to one or more specific APs;
APs with load in a specific load range; or
APs that operate in a specific frequency range.

18. The AP wireless device of claim 15,
wherein the BTM request frame includes a query response status indication.

19. The AP wireless device of claim 15,
wherein the BTM request frame includes reduced neighbor report (RNR) information in a candidate list entries field.

20. The AP wireless device of claim 15,
wherein a disassociation timer field and a link removal imminent subfield in a request mode field are reserved in the BTM request frame received in response to the BTM query frame.
